(19) United States
(12) Patent Application Publication
(10) Pub. No.: US 2013/0216832 A1
(43) Pub. Date: Aug. 22, 2013

(54) Heat Reflective Dry-Mix/Paint

(71) Applicants: Ramanand N. Jagtap, Mumbai (IN); Bhupesh Marathe, Mumbai (IN)

(72) Inventors: Ramanand N. Jagtap, Mumbai (IN); Bhupesh Marathe, Mumbai (IN)

(73) Assignee: Institute of Chemical Technology, Matunga, Mumbai, Maharashtra (IN)

(21) Appl. No.: 13/810,128

(22) PCT Filed: Jul. 11, 2011
(86) PCT No.: PCT/IN2011/000459

§ 371 Date: Apr. 2, 2013

(30) Foreign Application Priority Data
Jul. 12, 2010 (IN) 1495/MUM/2010

(51) Int. Cl. C09D 5/33

(52) U.S. Cl. CPC C09D 5/004
USPC 428/402; 106/449

(57) ABSTRACT

Heat reflective dry mix comprising of dry particulate, the said dry particulate matter comprising of pigment in the range of 20 to 45%, the balance proportion being extenders/fillers wherein the extenders/fillers shall consist of calcium carbonate not less than 15% with respect to total particulate matter having the average particle size of the dry particulate matter in the range of 2 to 6 micrometers.

### FIELD OF THE INVENTION

Present invention relates to a heat reflective paint. More particularly present invention relates to a heat reflective paint which reduces the power needs and enhances the life of the structure.

### BACKGROUND OF THE INVENTION AND PRIOR ART

Sunlight reaching the ground consists of UV, Visible and IR radiations with energy distribution of 5%, 46% and 49% respectively. Theses longer wavelength IR radiations are also known as “heat Radiations”, which are responsible for increasing the temperature of the buildings. The annual expenditure of cooling is multi billion dollars, cooling consumes around 35-40% of the total power. In order to conserve the natural environment, curb the negative impact of human involvement. Green building, part of Green/Clean Technology reduces the operating cost by increasing the productivity using lesser energy.

In the present art the available patent reports the use of heat reflective pigment (U.S. Pat. No. 6,989,056 and U.S. Pat. No. 6,294,010) whereas some have employed laminates consisting of IR reflecting particles of metal oxides (U.S. Pat. No. 4,272,291 and U.S. Pat. No. 4,546,045) mica or plastics. Others patents reported discusses about incorporation of hollow spheres to get the required performance properties. The process involved surface preparation, followed by application of primer and after proper curing the final top coat is applied.

In the prior art, the steps involved in the coating process are more in number moreover the final coating thickness is higher than required for providing the required performance properties.

### OBJECT OF THE PRESENT INVENTION

Object of the present invention aims at developing a heat reflective paint.

Yet another object of the present invention is to develop a dry mix/paint with fillers/extenders as a reflective material

Yet another object of the present invention is to develop a heat reflective paint which reduces the power needs and enhances the life of the structure.

One more object of the present invention is to develop the heat reflective paint which is cost effective having improved efficiency.

Yet another object of the present invention is to eliminate the primer coat thereby reducing the coating thickness required for the given performance.

One more object of the present invention is to develop a heat reflective paint having no solvents, Heavy metals, Hazards chemicals present in the formulation.

One more object of the present invention is to develop a paint which helps to maintain the temperature difference across the surface & gives a maximum heat reflection.

One more object of the present invention is to eliminate the deficiencies and or drawbacks of the prior art.

### STATEMENT OF THE INVENTION

According to this invention therefore, heat reflective dry mix comprising of dry particulate, the said dry particulate matter comprising of pigment in the range of 20 to 45%, the balance proportion being extenders/fillers wherein the extenders/fillers shall consist of calcium carbonate not less than 15% with respect to total particulate matter having the average particle size of the dry particulate matter in the range of 2 to 6 micrometers.

### BRIEF DESCRIPTION OF THE INVENTION

Heat reflective dry mix/paint in accordance with the present invention has been developed by using material of appropriate particle size. Scattering and particle size distribution helping in scattering of light. Particle size required for optimum light scattering is given by
D=λ/2.1 (Nₚ−N_{b})
D—Diameter of the particle
λ—Mean IR radiation
Nₚ—RI of pigment
N_{b}—RI of binder.

Heat reflectivity of coating is dependent on RI of the binder as well as the pigment. The relationship between reflectance and RI of pigment and vehicle is given by

R=(N_{P}−N_{V})/(N_{P}+N_{V})

### Where

R—Surface reflectance
N_{P}—RI of pigment
N_{V}—RI of vehicle

According to the Relight scattering principle higher the ratio of pigment to vehicle higher is the scattering power. Heat reflectivity depend also conductivity, insulation ability and coating thickness.

Heat reflective paint according to the present invention which is white coating or colour coating comprising of the following:

| | |
|---|---|
| Whitening Agents | 25-40% |
| Filler 1 | 15-20% |
| Filler 2 | 10-15% |
| Filler 3 | 10-15% |
| White pigment | 5-12% |
| Additive 1 | 0.2-1.2% |
| Additive 2 | 0.1-0.8% |

A colour heat reflective coating as per the present invention comprising of the following:

| | |
|---|---|
| Whitening Agents | 25-35% |
| Filler 1 | 10-15% |
| Filler 2 | 10-15% |
| Filler 3 | 01-15% |
| Pigment | 3-10% |
| Specialty pigment | 8-15% |

The whitening agents can be selected from the following materials.

White Portland cement, calcinedmagnesite, calcium carbonate, calcined china clay, magnesia, ziconium silicate and zirconia, titanium dioxide

The fillers used in the present invention can be selected from the following White Portland cement, Ethylene vinyl acetate redispersible emulsion, Titanium DiOxide, Calcium Carbonate, Talc, China Clay, Barytes, Solar Flair 9870, Solar Flair 9875,Complex Inorganic Color Pigment Green 187 B, Complex Inorganic Color Pigment Yellow 10C 112, Complex Inorganic Color Pigment Brown 20C 81, Complex Inorganic Color Pigment Brown 8, Complex Inorganic Color Pigment Black 411,OP-62 having appropriate predefined particle size.

Further the fillers may also be selected from Aluminum oxide, Aluminum oxide82, Calcite, Calcium, carbonate (ultrafine)84, Carbon fiber, Diatomaceous earth, Microporous polypropylene fiber, Precipitated silica39, Quartz, Sepiolite, Silica gel, Zeolites, expanded polymeric microspheres, hollow glass beads, thin-wall, hollow ceramic spheres, wood flour, porous ceramic spheres, silver coated glass beads, thicker wall, hollow ceramic spheres, polyethylene fibers and particles, cellulose fibers, unexpanded polymeric spheres, rubber particles, expanded perlite, anthracite, aramid fibers, carbon black, PAN-based carbon fibers, precipitated silica, pitch-based carbon fibers, fumed and fused silica graphite, sepiolite, diatomaceous earth, fly ash slate flour, PTFE, calcium hydroxide, silica gel, boron nitride, pumice, attapulgite, calcium sulfate ferrites, cristobalite, aluminum, trihydroxide, magnesium oxide and hydroxide, unexpanded perlite, solid ceramic spheres, solid glass beads, kaolin, and calcinated, kaolin, silver coated glass spheres and fibers glass fibers, feldspar, clay, hydrous calcium silicate, vermiculite, quartz and sand, pyrophyllite, aluminum powders and flakes, talc, nickel coated carbon fiber, calcium carbonate, mica, zinc borate, beryllium oxide, dolomite, wollastonite, aluminum borate whiskers, zinc stannate and hydroxystannate, silver coated aluminum powder, apatite, barium metaborate, titanium dioxide, antimony pentoxide), zinc sulfide (4), barium sulfate and barite, lithopone, iron oxides, sodium antimonite, silver coated inorganic flakes, molybdenum disulfide, antimony trioxide, zinc oxide, nickel powder and flakes, copper powder, silver coated copper powders, molybdenum powder (10.2). The fillers can be used either in isolation or in combination.

The additives, pigments and specialty pigments used to prepare the heat reflective paint are known in the art.

Heat reflective paint as per the present invention is Cost effective and truly green coating, as there are no solvents, Heavy metals, Hazards chemicals present in formulation. It is energy efficient coating which helps to maintain temperature difference across the surface & gives a maximum heat reflection.

### EXAMPLES

1. Heat reflective paint mixture according to the present invention comprising of 8% of TiO2 being pigment in the dry particulate matter. Calcium Carbonate being 41% being extender/filler.The entire dry particulate matter being of particle size between 4 to 5 micrometers.Binder being 35% of the total paint mixture.Binder being pure acrylic copolymer with the glass transition temperature of 10 to 15 Deg C. Mixing with water and known additives.

2. Heat reflective paint mixture according to the present invention comprising of 12% of TiO2 being pigment in the dry particulate matter. Calcium Carbonate being 15%, barytes 11%, talc 11% being extender/filler. The entire dry particulate matter being of particle size between 4 to 5 micrometers.Binder being 35% of the total paint mixture.Binder being pure acrylic copolymer with the glass transition temperature of 10 to 15 Deg C. Mixing with water and known additives.

3. Heat reflective paint mixture according to the present invention comprising of 18% of TiO2 being pigment in the dry particulate matter. Calcium Carbonate being 15%, barytes 10% and talc 6% being extender/filler. The entire dry particulate matter being of particle size between 4 to 5 micrometers.Binder being 35% of the total paint mixture.Binder being pure acrylic copolymer with the glass transition temperature of 10 to 15 Deg C. Mixing with water and known additives.

4. Heat reflective paint mixture according to the present invention comprising of 18% of TiO2 being pigment in the dry particulate matter. Calcium Carbonate being 17%, barytes 17% and talc 18% being extender/filler. The entire dry particulate matter being of particle size between 4 to 5 micrometers.Binder being 35% of the total paint mixture.Binder being pure acrylic copolymer with the glass transition temperature of 10 to 15 Deg C. Mixing with water and known additives.

### ADVANTAGES OF THE PRESENT INVENTION

1. The heat reflective paint in accordance with the present invention is Cost Effective.

2. The heat reflective paint in accordance with the present invention is Eco-Friendly green.

3. The heat reflective paint in accordance with the present invention is Energy Efficient.

1. Heat reflective dry mix comprising of dry particulate, the said dry particulate matter comprising of pigment in the range of 20 to 45%, the balance proportion being extenders/fillers wherein the extenders/fillers shall consist of calcium carbonate not less than 15% with respect to total particulate matter having the average particle size of the dry particulate matter in the range of 2 to 6 micrometers.

2. The heat reflective dry mix as claimed in claim 1 above, wherein, the said pigment is selected from TIO2, hollow polymers, hollow ceramic beads in combination or isolation.

3. The heat reflective dry mix as claimed in claim 1 above, wherein the said pigment is with or without coloring agents.

4. The heat reflective dry mix as claimed in claims 1 wherein the said dry film thickness of the coating is not less than 70 micrometers.

5. The heat reflective dry mix as claimed in claims 1, wherein the said dry mix can be in the form of free flowing powder or combined with either water base or solvent based binder to yield paint in paste form as per the application.

6. The heat reflective dry mix as claimed in claim 1, wherein the h fillers/extenders acts as a as a reflective material.

7. The heat reflective dry mix as claimed in claim 1, and as described with reference to the examples given in the specification.

8. The heat reflective dry mix as claimed in claim 2 above, wherein the said pigment is with or without coloring agents.

9. The heat reflective dry mix as claimed in claim 3 above wherein the said dry film thickness of the coating is not less than 70 micrometers.

10. The heat reflective dry mix as claimed in claim 4 above, wherein the said dry mix can be in the form of free flowing powder or combined with either water base or solvent based binder to yield paint in paste form as per the application.

11. The heat reflective dry mix as claimed in claim 15, wherein the h fillers/extenders acts as a as a reflective material.

12. The heat reflective dry mix as claimed in claim 5, and as described with reference to the examples given in the specification.
